(19) United States
(12) Patent Application Publication
(10) Pub. No.: US 2011/0079288 A1
(43) Pub. Date: Apr. 7, 2011

(54) METHOD AND APPARATUS FOR PREVENTING ENERGY LEAKAGE FROM ELECTRICAL TRANSMISSION LINES

(75) Inventors: Eckhard Bez, Littleton, MA (US); Melanie Rosay, Bedford, MA (US); Leo Tometich, Dunstable, MA (US)

(73) Assignee: BRUKER BIOSPIN CORPORATION, Billerica, MA (US)

(21) Appl. No.: 12/571,930

(22) Filed: Oct. 1, 2009

(51) Int. Cl. F17D 3/00

(52) U.S. Cl. 137/12; 137/560

(57) ABSTRACT

Apparatus for preventing energy leakage from a transmission line treats the line as a “partially closed” vessel. A gas stream with a pressure slightly different from ambient pressure is provided to the interior of the transmission line and a conduit that allows gas to pass between the transmission line and the ambient environment is provided. The gas flow rate at the conduit is then detected and monitored. If the flow rate falls outside a predetermined threshold, an electrical energy leakage is indicated. In another embodiment, the pressure of the input gas to the transmission line is continuously checked by a pressure switch, which will detect a change in pressure if the transmission integrity is compromised and disable the energy source.

### BACKGROUND

Electrical energy is often transmitted from a source to a destination via a waveguide or transmission line. Transmission line designs vary considerably depending on the geometry between the source and destination, and the frequency and energy level of the electrical energy. For example, microwave energy is often transmitted via a closed waveguide resembling a rectangular pipe. Typically, a microwave transmission line is fabricated from various waveguide sections and microwave modification components that are connected together to transmit energy from the source to the destination.

The proper alignment of the transmission line sections and components is critical for efficient electrical energy transmission. In addition, any misalignment between transmission line components creates the potential for energy leakage. In some cases, excessive energy leakage levels can present a hazard to personnel or equipment.

Various conventional methods have been used to either detect energy leakage or to prevent injury to personnel and equipment if such leakage does occur. For example, one common approach is to physically secure the area where the transmission system is located. This approach is often impractical where the transmission system is too large to be enclosed or where it is necessary to an operator be present to operate the system. In addition, such an arrangement would effectively require a mechanism that disables the energy source when personnel are present. Further, without special construction, conventional walls or doors may not prohibit energy transmission.

Another conventional approach is to enclose the transmission line components in a protective metal enclosure. Although this approach ensures no energy leakage beyond the enclosure, it does not detect transmission line misalignment, which could affect equipment operation and energy transmission efficiency. In addition, if part of the transmission line must be removable, there is no mechanism for ensuring that the removable part is re-attached before enabling the energy source.

Still another approach is to use either mechanical or optical switches attached to the transmission line components to ensure correct component placement. However, in systems with numerous components, it is difficult to position and connect enough switches to verify correct placement of the components, especially if portions of the line are removable. Another concern is the ease with which switches can be bypassed or overridden.

Yet another approach is to apply a small current to one end of the transmission line and monitor the opposite end of the transmission line for the same current. However, some transmission lines have intentional electrical break points in the line. Consequently, this approach would not monitor the portions of the transmission line beyond these break points. Other transmission line systems are mounted on electrically conductive rails and therefore could have electrical conductivity without proper alignment between adjacent microwave components.

A further approach is to use a light curtain or proximity sensors. This requires multiple detectors to cover the area in which the transmission system is located and is costly. In addition, the sensors can detect when personnel or objects enter the area near the transmission system, but do not address component misalignment and associated potential energy leakage.

### SUMMARY

In accordance with the principles of the invention, the transmission line is treated as a “partially closed” vessel. A gas stream with a pressure slightly different from ambient pressure is provided to the interior of the transmission line and a conduit between the transmission line and the surrounding environment is provided to allow gas to pass between the interior of the transmission line and the ambient environment. The gas flow rate at the conduit is then detected and monitored. If the flow rate falls outside a predetermined threshold, an electrical energy leakage is indicated. This method can compensate for small steady state leaks along the transmission line assembly, and monitors for misalignment throughout the length of the transmission line.

In another embodiment, the pressure of the input gas to the transmission line is continuously checked by a pressure switch, which will detect a change in pressure if the transmission integrity is compromised and disable the energy source.

### BRIEF DESCRIPTION OF THE DRAWINGS

FIG. 1 is a block schematic diagram showing the inventive transmission line integrity monitoring apparatus.

FIG. 2 is a flowchart illustrating steps in an illustrative method for preventing energy leakage from electrical transmission lines.

FIG. 3 is a schematic diagram showing an application of the energy leakage monitoring apparatus to a waveguide of a nuclear magnetic resonance system.

### DETAILED DESCRIPTION

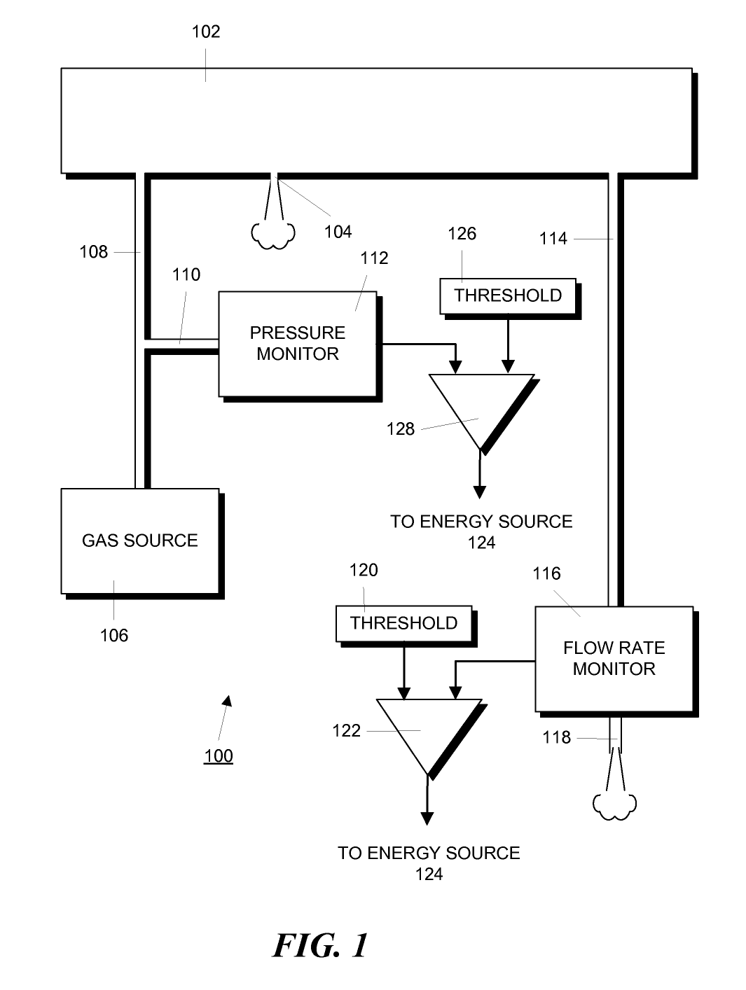

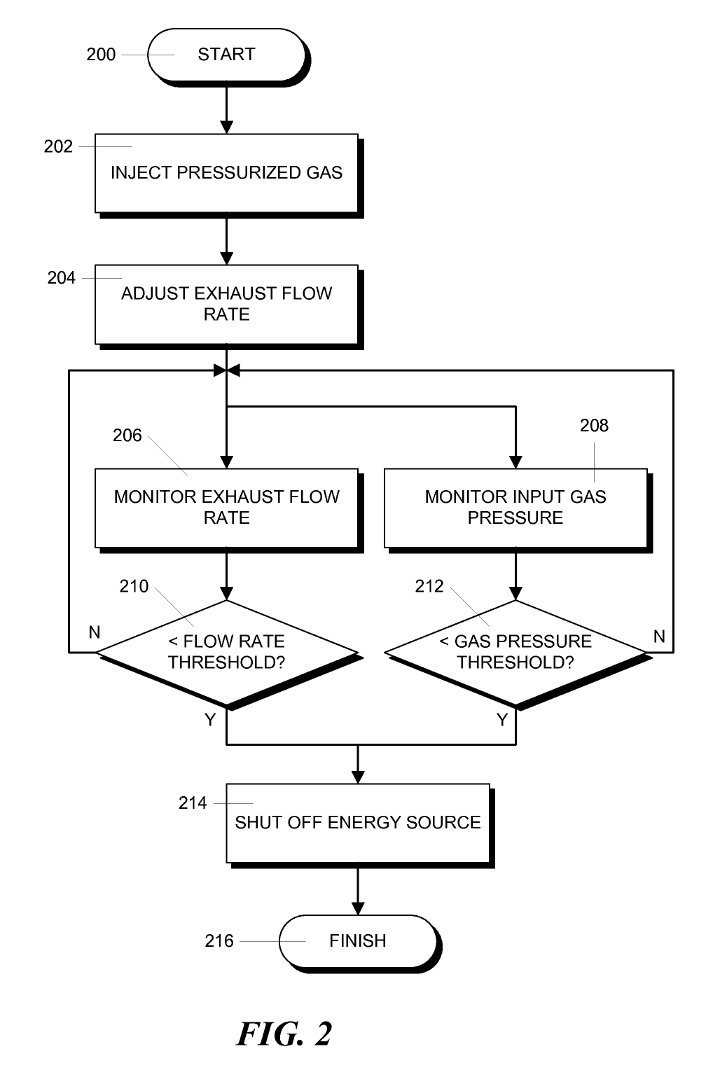

FIG. 1 illustrates the apparatus that comprises the inventive monitoring system 100 and FIG. 2 is a flowchart showing the steps in a method for its use. In accordance with the principles of the invention, the transmission line, including all components connected between the electrical energy source and the energy destination or any subset thereof, is treated as a partially closed vessel 102. As used herein a partially closed vessel is a closed vessel in which at least one steady state leak exists. In FIG. 1 all steady state leaks in the system are treated together and shown as cumulative leak 104.

The method for monitoring transmission line electrical integrity begins in step 200 and proceeds to step 202 where gas from gas source 106 is injected into the transmission line 102 via gas input 108. This gas is typically at a pressure slightly different from ambient pressure. This pressure can be either slightly above ambient pressure or slightly below ambient pressure. In the discussion below, it is assumed that this pressure is slightly above ambient pressure. However, those skilled in the art would understand that a pressure slightly below ambient pressure could also be used without departing from the principles of the invention. In one embodiment, the gas pressure is 1.5 PSI to 3.5 PSI. A gas pressure monitor 112 is attached to gas input 108, for example, by connection 110 as shown in FIG. 1. The gas exits the transmission line system 102 via a gas conduit 114. The gas conduit 114 is connected to a gas flow rate monitor 116 through which the gas flows before finally exiting the system at 118. Although FIG. 1 shows the gas as exiting at 118 to the atmosphere, those skilled in the art would understand that other arrangement could be made for the gas exhaust.

In step 204, at the time of installation of the monitoring system, the input gas pressure is adjusted so that the exhaust gas flow rate from the transmission line is equal to a predetermined minimum amount, for example 1 SLPM. This adjustment compensates for small steady-state gas leaks 104 in each transmission line assembly.

In step 206, during operation, the gas flow monitor 116 continuously monitors the exhaust gas flow rate. Any misalignment or displacement between transmission line components allows additional gas to escape, thus reducing gas flow through the flow rate monitor 116. The output of flow rate monitor 116 is connected to a comparator 122 which compares the output to a predetermined minimum flow rate threshold 120, which may, for example, be set to approximately 1SLPM. If exhaust flow rate monitor output signal falls below the minimum flow rate threshold as determined in step 210, the comparator output signal changes state and, in step 214, shuts off the energy source until the transmission line misalignment is corrected. The method then ends in step 216. Those skilled in the art would understand that the comparator 122 could be replaced with an equivalent mechanical or electromechanical mechanism.

Alternatively, if in step 210, it is determined that the exhaust gas flow rate detected by monitor 116 is not below the threshold, then the method returns to step 206 to continue monitoring the exhaust gas flow rate.

In another embodiment, in addition to monitoring the exhaust gas flow rate, the pressure of the input gas to the transmission line is continuously checked in step 208 by a pressure monitor 112. The output of the pressure monitor 112 is connected to a comparator 128 which compares it to a minimum pressure threshold 126. If the transmission line integrity is compromised, the output of the pressure monitor 112 will fall below the threshold as detected in step 212 and the energy source will be shut off as indicated in step 214. The method then ends in step 216. Those skilled in the art would understand that the comparator 128 could be replaced with an equivalent mechanical or electromechanical mechanism.

Alternatively, if in step 212, it is determined that the input gas pressure detected by monitor 112 is not below the threshold, then the method returns to step 206 to continue monitoring the input gas pressure.

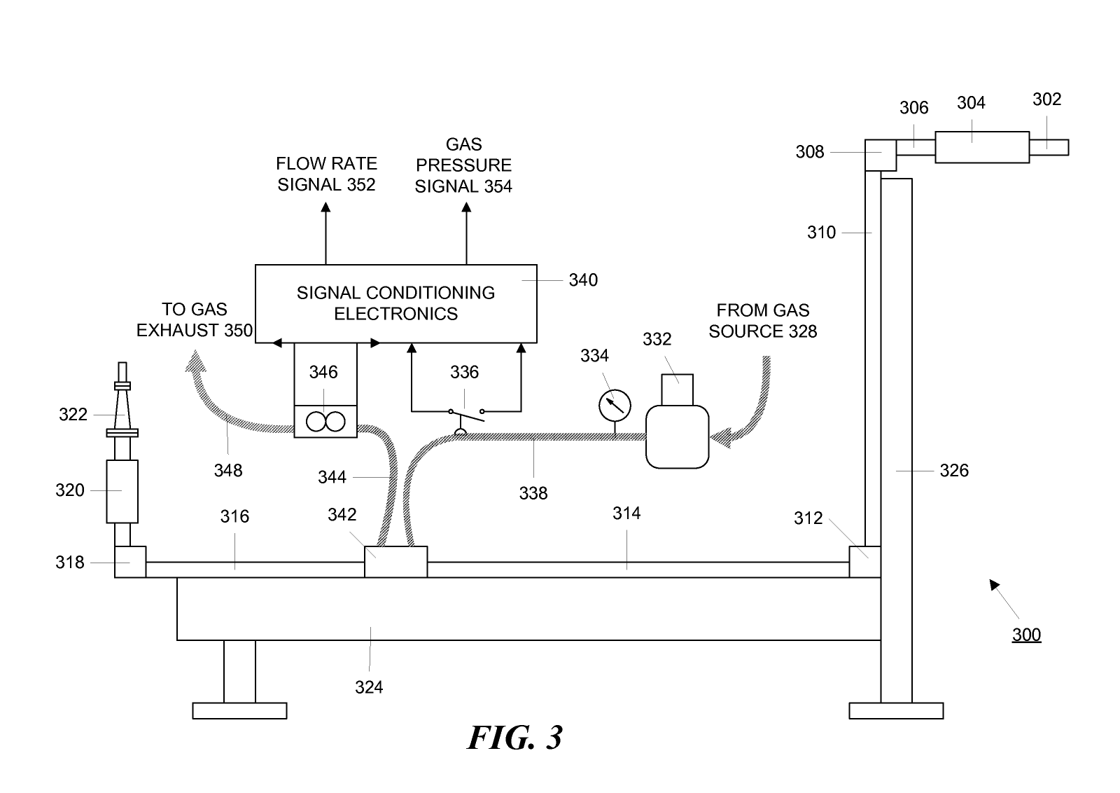

FIG. 3 illustrates the application of the inventive monitoring apparatus to a microwave waveguide used in a nuclear magnetic resonance apparatus 300. The microwave waveguide comprises a plurality of components, including waveguide sections 302, 306, 310, 314 and 316. The waveguide sections are connected together by corner connectors 308, 312 and 318. Other components may include attenuators 304 and 320. The waveguide conducts microwave energy from a microwave source located at the right side of the figure (not shown in FIG. 3) and connected to waveguide section 302 to the NMR probe 322 at the left side of the figure. The waveguide is supported on a conductive stand comprising bed 324 and riser 326.

Pressurized gas from gas source 328 (not shown in FIG. 3) is applied to a pressure regulator 332 to reduce the source pressure to a constant low pressure. This pressure can be monitored via pressure gauge 334. The low pressure gas is provided via conduit 338 to a coupler 342 connected between waveguide sections 314 and 316. The coupler 342 injects the pressurized gas into the interior of the waveguide transmission line.

The coupler 342 also allows gas to exit the transmission line via conduit 344. Conduit 344 is, in turn, connected to gas flow rate monitor 346. The exhaust gas exits the flow rate monitor 346 via conduit 348 to a gas exhaust 350 (not shown in FIG. 3). During operation, the flow rate monitor 346 provides flow rate signals to the signal conditioning electronics 340. In addition, if the gas input pressure drops below a predetermined minimum gas pressure threshold, the pressure switch 336 detects this condition and notifies signal conditioning electronics 340. Signal conditioning electronics 340 generates a flow rate signal 352 when the exhaust gas flow rate falls below a predetermined minimum flow rate threshold. Signal conditioning electronics 340 also generates a gas pressure signal 354 when the pressure switch 336 indicates that the input gas pressure has fallen below the predetermined minimum gas pressure threshold. Either signal 352 or 354 can be used to turn off the microwave energy source.

The inventive system can thus detect waveguide misalignment and integrity breaches. In addition, a failure in the pressurized gas source will also be detected.

While the invention has been shown and described with reference to a number of embodiments thereof, it will be recognized by those skilled in the art that various changes in form and detail may be made herein without departing from the spirit and scope of the invention as defined by the appended claims.

What is claimed is:

1. Apparatus for preventing energy leakage from a partially closed electrical transmission line connected to an energy source and located in an ambient environment, comprising:
a gas source that injects gas with a gas pressure into the transmission line;
a conduit connected to the transmission line that allows gas to pass between the transmission line and the ambient environment with a flow rate; and
a first monitor that shuts down the energy source when the flow rate falls outside a predetermined flow rate threshold.

2. The apparatus of claim 1 further comprising a second monitor that shuts down the energy source when the gas pressure falls outside a predetermined gas pressure threshold.

3. The apparatus of claim 2 wherein the second monitor comprises a gas pressure monitor that measures the pressure of the injected gas and a comparator that compares the measured gas pressure to the predetermined gas pressure threshold.

4. The apparatus of claim 2 wherein the second monitor comprises a pressure switch.

5. The apparatus of claim 1 wherein the first monitor comprises a flow rate monitor that measures the flow rate and a comparator that compares the measured flow rate to the predetermined flow rate threshold.

6. A method for preventing energy leakage from a partially closed electrical transmission line connected to an energy source and located in an ambient environment, comprising:
(a) injecting gas with a gas pressure into the transmission line;
(b) connecting a conduit to the transmission line to allow gas to pass between the transmission line and the ambient environment with a flow rate; and
(c) shutting down the energy source when the flow rate falls outside a predetermined flow rate threshold.

7. The method of claim 6 further comprising:
(d) shutting down the energy source when the gas pressure falls outside a predetermined gas pressure threshold.

8. The method of claim 7 wherein step (d) comprises measuring the pressure of the injected gas and comparing the measured gas pressure to the predetermined gas pressure threshold.

9. The method of claim 6 wherein step (c) comprises measuring the flow rate and comparing the measured flow rate to the predetermined flow rate threshold.

10. Apparatus for preventing energy leakage from a partially closed microwave waveguide connecting a microwave source to a probe in a nuclear magnetic resonance measuring system and located in an ambient environment, comprising:
a coupler inserted into the waveguide between the microwave source and the probe;
a gas source that injects gas with a gas pressure into the waveguide via the coupler;
a conduit exhaust connected to the interior of the waveguide via the coupler that allows gas to pass between the waveguide and the ambient environment with a flow rate; and
a first monitor that shuts down the microwave source when the flow rate falls outside a predetermined flow rate threshold.

11. The apparatus of claim 10 further comprising a second monitor that shuts down the microwave source when the gas pressure falls outside a predetermined gas pressure threshold.

12. The apparatus of claim 11 wherein the second monitor comprises a gas pressure monitor that measures the pressure of the injected gas and a comparator that compares the measured gas pressure to the predetermined gas pressure threshold.

13. The apparatus of claim 11 wherein the second monitor comprises a pressure switch.

14. The apparatus of claim 10 wherein the first monitor comprises a flow rate monitor that measures the flow rate and a comparator that compares the measured flow rate to the predetermined flow rate threshold.

15. Apparatus for preventing energy leakage from a partially closed electrical transmission line connected to an energy source, comprising:
a gas source that injects gas with a gas pressure into the transmission line; and
a monitor that shuts down the energy source when the gas pressure falls outside a predetermined gas pressure threshold.

16. The apparatus of claim 15 wherein the monitor comprises a gas pressure monitor that measures the pressure of the injected gas and a comparator that compares the measured gas pressure to the predetermined gas pressure threshold.

17. The apparatus of claim 15 wherein the monitor comprises a pressure switch.
